(19) United States
(12) Patent Application Publication
(10) Pub. No.: US 2007/0108719 A1
(43) Pub. Date: May 17, 2007

(54) Auxiliary balancing device for a retractable step assembly

(76) Inventor: Peter Yeh, Hsinhua Chen (TW)

Correspondence Address: Thomas E. Sisson;Jackson Walker, LLP, Suite 2100, 112 E. Pecan, San Antonio, TX, 78205, US

(21) Appl. No.: 11/272,623

(22) Filed: Nov. 14, 2005

(51) Int. Cl. B60R 3/00

(52) U.S. Cl. 280/166

(57) ABSTRACT

An auxiliary balancing device for a retractable step assembly is mounted between two distal ends of two linkages of the retractable step assembly and includes two driving gears and an interaction gear assembly. The two driving gears are mounted to the two distal ends of the two linkages, respectively. The interaction gear assembly is mounted between and meshes with the two driving gears so that the two driving gears rotate synchronously. Thus, the step of the retractable step assembly can be kept balanced and horizontal when being lowered or raised.

### BACKGROUND OF THE INVENTION

1. Field of the Invention

The present invention relates to a balancing device, and more particularly to an auxiliary balancing device for a retractable step assembly.

2. Description of the Related Art

Many vehicles, such as buses or passenger coaches of trains, are equipped with retractable steps to aid in boarding or disembarking the vehicle.

With reference to FIG. 3, a conventional retractable step assembly in accordance with the prior art comprises a base (80), a driving device (81), a right linkage (84), a left linkage (85), and a step (90).

The base (80) is mounted below an entrance/exit of a vehicle (not shown).

The driving device (81) is mounted on the base (80) and has a right shaft (82) and a left shaft (83). When the driving device (81) operates, the right shaft (82) and the left shaft (83) rotate in opposite directions synchronously.

The right linkage (84) and the left linkage (85) are both articulated. The right linkage (84) comprises a right upper arm (841) and a right lower arm (842). The right upper arm (841) has a proximal end (not numbered) and a distal end (not numbered). The proximal end of the right upper arm (841) is mounted on the right shaft (82). The right lower arm (842) has a proximal end (not numbered) and distal end (not numbered). The proximal end of the right lower arm (842) is mounted to the distal end of the right upper arm (841) pivotally.

The left linkage (85) comprises a left upper arm (851) and a left lower arm (852). The left upper arm (851) has a proximal end (not numbered) and a distal end (not numbered). The proximal end of the left upper arm (851) is mounted to the left shaft (82). The left lower arm (852) has a proximal end (not numbered) and a distal end (not numbered). The proximal end of the left lower arm (852) is mounted to the distal end of the left upper arm (851) pivotally.

The step (90) is mounted pivotally to the distal end of the right lower arm (842) and the distal end of the left lower arm (852).

When the driving device (841) operates, the right shaft (82) and the left shaft (83) rotate in opposite directions synchronously. With reference to FIG. 3, when the right shaft (82) rotates clockwise and the left shaft (83) rotates counterclockwise, the distal end of the right upper arm (841) and the distal end of the left upper arm (851) move toward each other, the right linkage (84) and the left linkage (85) extend longitudinally, and the step is lowered down. Passengers can step on the step (90) to get on/off the vehicle. With reference to FIG. 4, When the right shaft (82) rotates counterclockwise and the left shaft (83) rotates clockwise, the distal ends of the right upper arm (841) and the left upper arm (851) lift up, the right linkage (84) and the left linkage (85) retract, and the step (90) is raised.

With reference to FIG. 4, as the right lower arm (842) and the left lower arm (852) are mounted pivotally to the right upper arm (841) and the left upper arm (851), respectively, and the step (90) is mounted pivotally to the right lower arm (842) and the left lower arm (852), the distal ends of the right lower arm (842) and the left lower arm (852) cannot be controlled precisely. The step (90) may not be balanced and horizontal when the right linkage (84) and the left linkage (85) extend or retract. Stepping on an inclined step (90) while getting on/off a vehicle would be unsafe for passengers.

### SUMMARY OF THE INVENTION

The primary objective of the present invention is to provide an auxiliary balancing device to implement in a retractable step assembly keep a step of the step assembly balanced and horizontal when the step is extended or retracted.

The retractable step assembly comprises a driving device, two articulated linkages and a step. The driving device has two shafts. When the driving device operates, the shafts rotate in opposite directions synchronously. Each linkage has a proximal end and a distal end. The proximal ends of the linkages are mounted to the shafts, respectively. The linkages are extended or retracted by the driving device. The step is mounted to the distal ends of the two linkages pivotally. The two linkages extend to lower the step and retract to raise the step.

The auxiliary balancing device in accordance with the present invention comprises two driving gears and an interaction gear assembly.

The two driving gears are mounted or formed at the distal ends of the two linkages, respectively.

The interaction gear assembly is mounted between and meshes with the two driving gears so the two driving gears will rotate synchronously. Thus, the step of the retractable step assembly can be kept balanced and horizontal when being lowered or raised.

### BRIEF DESCRIPTION OF THE DRAWINGS

FIG. 1 is a rear view of a retractable step assembly with an auxiliary balancing device in accordance with the present invention;

FIG. 2 is an operational rear view of the retractable step assembly with the auxiliary balancing device in FIG. 1;

FIG. 3 is a front view of a conventional retractable step assembly in accordance with the prior art; and

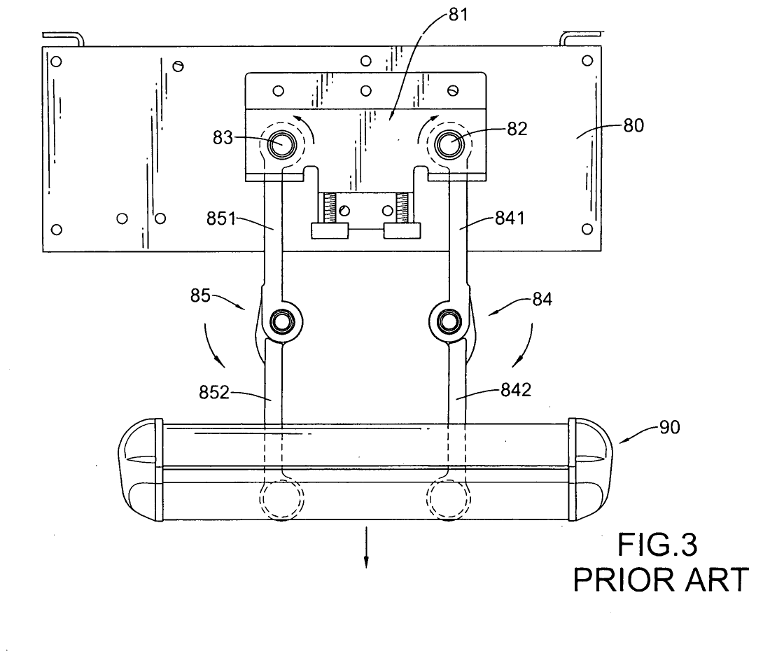

FIG. 4 is an operational front view of the conventional retractable step assembly in FIG. 3.

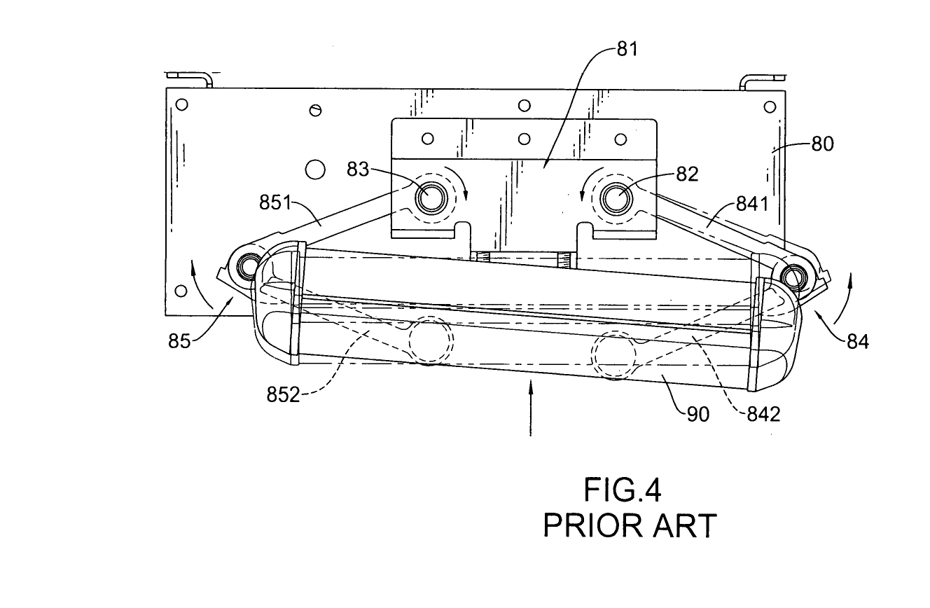

### DETAILED DESCRIPTION OF THE PREFERRED EMBODIMENT

An auxiliary balancing device for a retractable step assembly in accordance with the present invention is implemented in a retractable step assembly.

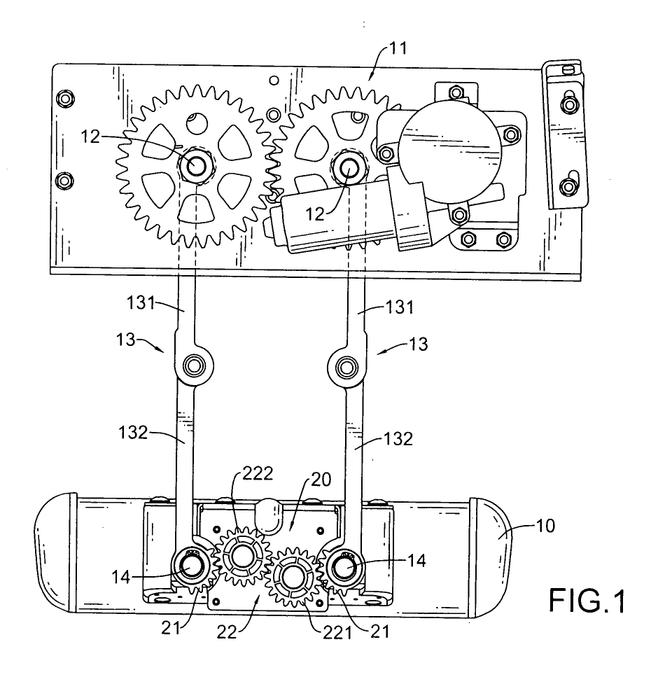

With reference to FIG. 1, a retractable step assembly comprises a driving device (11), two articulated linkages (13), and a step (10).

The driving device (11) contains two shafts (12). When the driving device operates, the two shafts (12) rotate in opposite directions synchronously.

The two linkages (13) each have an upper arm (131) and a lower arm (132). The upper arm (131) has a proximal end and a distal end. The proximal end of an upper arm (131) is mounted to a shaft (12). The lower arm (132) has a proximal end and distal end (14). The proximal end of the lower arm (132) is mounted pivotally to the distal end of the upper arm (131).

The step (10) is mounted pivotally to the distal ends (14) of the two lower arms (132).

With reference to FIG. 1, a preferred embodiment of the auxiliary balancing device (20) is mounted between the distal ends (14) of the two lower arms (132) and comprises two driving gears (21), and an interaction gear assembly (22).

The two driving gears (21) are mounted at the distal ends (14) of the two lower arms (132), respectively, and may be implemented in several ways. In one implementation, each driving gear (21) is formed as an integral part of the corresponding lower arm (132). In another implementation, a separate driving gear (21) can be mounted to the distal end (14) of the corresponding lower arm (132).

The interaction gear assembly (22) is mounted between the two driving gears (21) and contains an even number of identical interaction gears (221,222) meshing with the two driving gears (21). In this embodiment, the interaction gear assembly (22) has two identical interaction gears (221,222). The two interaction gears (221,222) mesh with adjacent driving gears (21) and with each other.

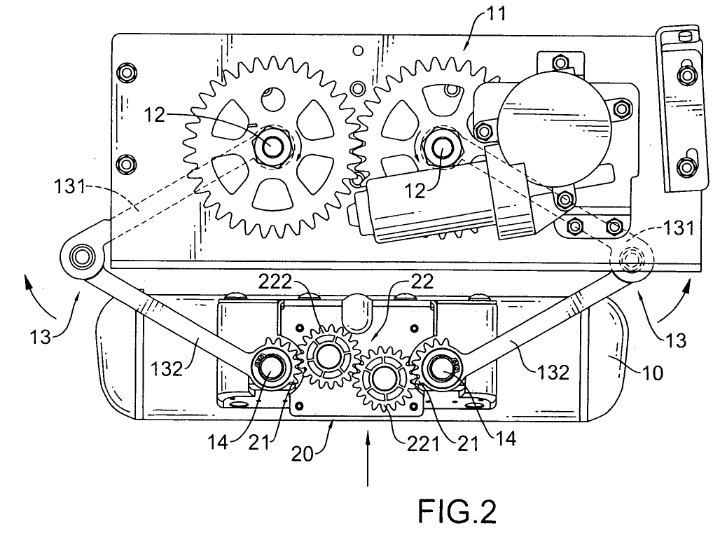

Operating the driving device (11), the two shafts (12) rotate in opposite directions synchronously to lower or raise the step (10). With reference to FIG. 2, when the driving device (11) operates, the two shafts (12) rotate in opposite directions synchronously, the two linkages (13) retract and the step (10) is raised. The two interaction gears (221,222) are meshed with adjacent driving gears (21) and with each other, so when the two linkages (13) extend and retract synchronously to lower and raise the step (10), the step (10) remains balanced and horizontal. People can step on the step (10) of the step assembly to get on/off a vehicle safely.

What is claimed is:

1. An auxiliary balancing device for being mounted between two distal ends of two linkages of a retractable step assembly and comprising:
two driving gears adapted for being mounted at the two distal ends of the two linkages respectively; and
an interaction gear assembly mounted between and meshing with the two driving gears so that the two driving gears rotate synchronously.

2. The auxiliary balancing device as claimed in claim 1, wherein the interaction gear assembly contains an even number of identical interaction gears.
